(19) United States
(12) Patent Application Publication
(10) Pub. No.: US 2026/0211766 A1
(43) Pub. Date: Jul. 23, 2026

(54) PROGRESSIVE SYSTEM HEALTH ASSESSMENT

(71) Applicant: Charter Communications Operating, LLC, St. Louis, MO (US)

(72) Inventors: Michael Detty, Lafayette, CO (US); Taren McCullough, Plymouth, MN (US); Michael Mulh, Centennial, CO (US); Ivan Grinev, Washougal, WA (US)

(21) Appl. No.: 19/035,683

(22) Filed: Jan. 23, 2025

(51) Int. Cl. G06F 11/07

(52) U.S. Cl. CPC G06F 11/0793; G06F 11/0709

(57) ABSTRACT

Gather a time series of reliability-pertinent data for at least one hardware element. Determine a risk factor for the at least one hardware element based on the time series of reliability-pertinent data. Responsive to the risk factor of the at least one hardware element having a predetermined relationship to a baseline, facilitate at least one remedial action for the at least one hardware element.

### FIELD OF THE INVENTION

The present invention relates generally to the electrical, electronic and computer arts, and, more particularly, to electronic devices, networking, and network management.

### BACKGROUND OF THE INVENTION

Electronic devices and systems, including networking equipment, servers, computers, appliances, customer premise equipment (CPE) and the like, typically suffer from degraded performance and failure as they age in the field. A primary in-field contribution to early device failure is increased thermal operating temperature. Devices and systems do not conventionally log this information in a way that allows estimation of its effect on a future failure of the device or system. Without a re-analysis of the CPE components, there is no insight into when a failure of a device and/or system might occur, or if the reliability is degrading faster than expected. There is no metric that is conventionally gathered that would indicate that the CPE should be pulled from a deployment, pulled from circulation, pulled from inventory, and the like. The CPE may continue to operate or be redeployed when its effective reliability has been reduced, causing unexpected failures, unplanned outages for the customer, additional truck rolls/service calls/trouble calls to replace the CPE or other device, and the like.

### SUMMARY OF THE INVENTION

Principles of the invention provide progressive system health assessment. In one aspect, an exemplary method includes the operations of gathering a time series of reliability-pertinent data for at least one hardware element; determining a risk factor for the at least one hardware element based on the time series of reliability-pertinent data; and, responsive to the risk factor of the at least one hardware element having a predetermined relationship to a baseline, facilitating at least one remedial action for the at least one hardware element.

In another aspect, an exemplary non-transitory computer readable medium includes computer executable instructions which when executed by a computer cause the computer to perform the method of: gathering a time series of reliability-pertinent data for at least one hardware element; determining a risk factor for the at least one hardware element based on the time series of reliability-pertinent data; and, responsive to the risk factor of the at least one hardware element having a predetermined relationship to a baseline, facilitating at least one remedial action for the at least one hardware element.

In still another aspect, an exemplary system includes a memory; and at least one processor, coupled to the memory, and operative to: gather a time series of reliability-pertinent data for at least one hardware element; determine a risk factor for the at least one hardware element based on the time series of reliability-pertinent data; and, responsive to the risk factor of the at least one hardware element having a predetermined relationship to a baseline, facilitate at least one remedial action for the at least one hardware element.

In a further aspect, an exemplary hardware element includes at least one functional electronic circuit; and a controller coupled to the at least one functional electronic circuit. The at least one controller is configured to: gather a time series of reliability-pertinent data for the at least one functional electronic circuit; determine a risk factor for the at least one functional electronic circuit based on the time series of reliability-pertinent data; and, responsive to the risk factor of the at least one functional electronic circuit having a predetermined relationship to a baseline, facilitating at least one remedial action for the at least one functional electronic circuit.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps (or a system wherein one or more such apparatuses are networked together, optionally with one or more other components). Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
improving the technological process of operating a network by proactively
enhancing reliability through the early identification and mitigation/replacement of network components nearing end of life based on network telemetry;
mechanisms for monitoring the health of a hardware element which undergoes variable thermal stress and mitigating the potential failure of the hardware element (if it is approaching failure, being subjected to adverse conditions, or both);
increased insight granularity into the effective lifespan of a hardware element, including improved accuracy in determining the remaining lifespan;
proactive customer premise equipment (CPE) maintenance or replacement to reduce unplanned customer outages;
reduction of truck rolls/service calls/trouble calls for faulty CPEs due to component failure;
additional inventory management accuracy;
estimation of functional units percentage at time t (i.e., how many units will be functional at a certain thermal state; while this assumes constant thermal manager state, the most common thermal state at time, t, can be evaluated to make this prediction);
reduction of unplanned CPE replacement due to component failure (leading to increased customer satisfaction);
proactive rather than reactive CPE replacement (leading to increased customer satisfaction);
more accurate inventory management for spare hardware elements, leading to reduced operations costs;
hardware element design optimization and better cost alignment and reliability leading to reduced capital expenses;
quantification of hardware element usage risk (see equations 2-4; equations are in the drawings) based on active thermal environment and usage level;
applicable to any industry where failure metrics are applied (such as mean time to failure (MTTF), mean time to repair (MTTR), mean time between failures (MTBF) and the like) and fluctuate based on usage and environment; and
enables industry governing bodies to evaluate live and projected hardware failure risk (see equation 4) from customer usage and determine individual thresholds for service.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 illustrates mathematical relationships for determining the health of a hardware element which undergoes variable thermal stress, in accordance with example embodiments;

FIG. 11 illustrates example MTBF values and age factor values for a hardware element having an MTBF specification of 300,000 hours and. design lifetime of 30,000 hours;

FIG. 12 is a graph of a CPE risk factor over the entire lifetime of a baseline hardware element and example hardware elements A-C, in accordance with example embodiments;

FIG. 13 is a graph of a CPE risk factor over the entire lifetime of a baseline hardware element and example hardware elements A-C, in accordance with example embodiments;

FIG. 14 is a table for hardware element parameters based on thermal state, in accordance with example embodiments;

FIG. 15 is a graph of a CPE risk factor over the entire lifetime of a baseline hardware element and example hardware elements A-C, in accordance with example embodiments;

FIG. 16 is a flowchart of an example method for monitoring a health of a hardware element which undergoes variable thermal stress, in accordance with example embodiments; and

FIG. 17 shows an exemplary hardware element, according to an aspect of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

One or more embodiments can be employed to carry out progressive system health assessment for individual hardware elements which undergo variable thermal stress and/or for network-connected hardware elements which undergo variable thermal stress connected to many different types of networks. One non-limiting example of such a network is a hybrid fiber-coaxial (HFC) network; other non-limiting examples include fiber optic networks such as fiber to the home (FTTH) networks. HFC and FTTH networks and the like can, in some instances, deliver video programs as well as data; the skilled artisan will understand from the context whether a “program” refers to a video program or a computer program. As noted above, electronic devices and systems, including networking equipment, servers, computers, appliances, customer premise equipment (CPE) and the like, typically suffer from degraded performance and failure as they age in the field. It is worth noting that equipment in a customer's premises can be subject to health assessment and mitigation using aspects of the invention, whether owned by a network operator, the customer, or a third party. Different mitigation actions could be taken, for example, based on who owns the equipment. In a non-limiting example, for user-owned hardware, the hardware itself issues a notification of high risk usage, and advises the user of mitigation options. The hardware would not necessarily be pulled from production or serviced (but could be if desired). Generally, owned vs. leased hardware could have different mitigation actions.

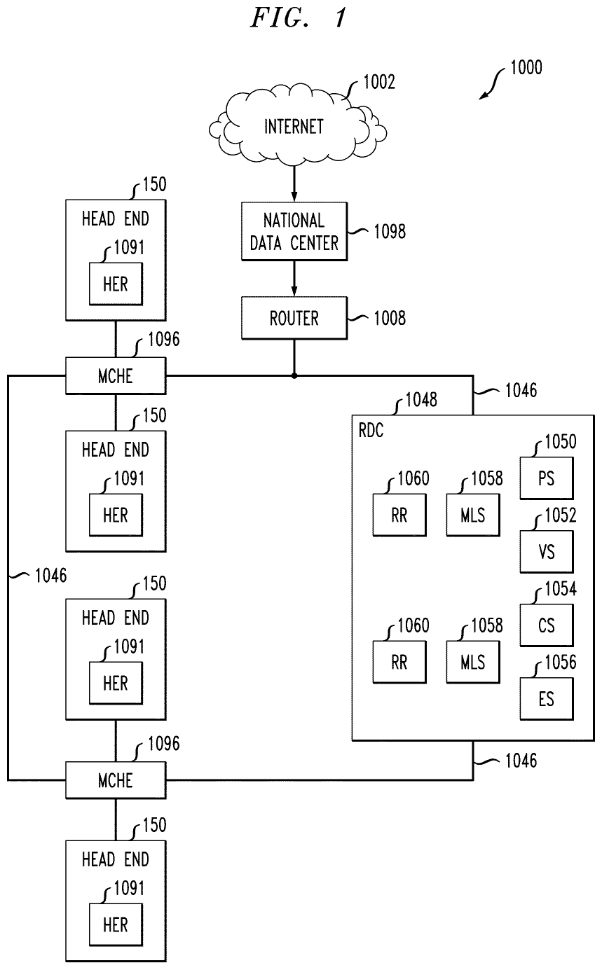

Thus, purely by way of example and not limitation, a description will be provided of a cable multi-service operator (MSO) providing data services as well as entertainment services, as an example environment in which aspects of the invention could be employed, it being understood that aspects of the invention could be employed in many different network environments. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

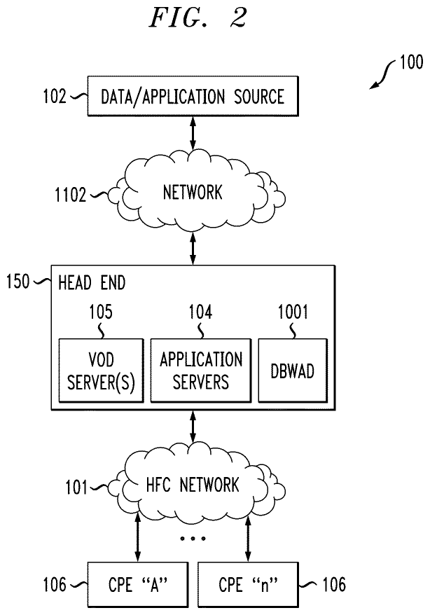

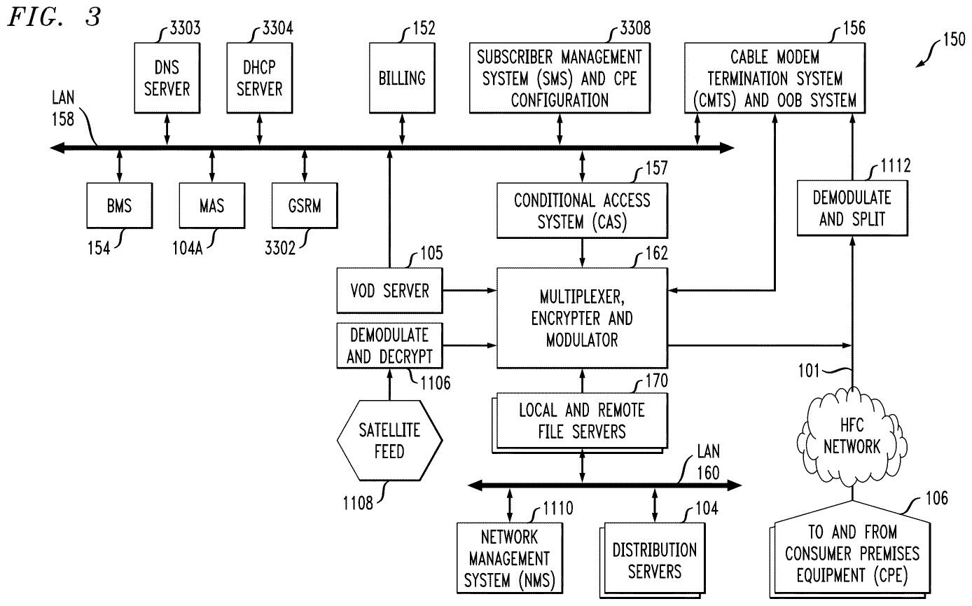

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

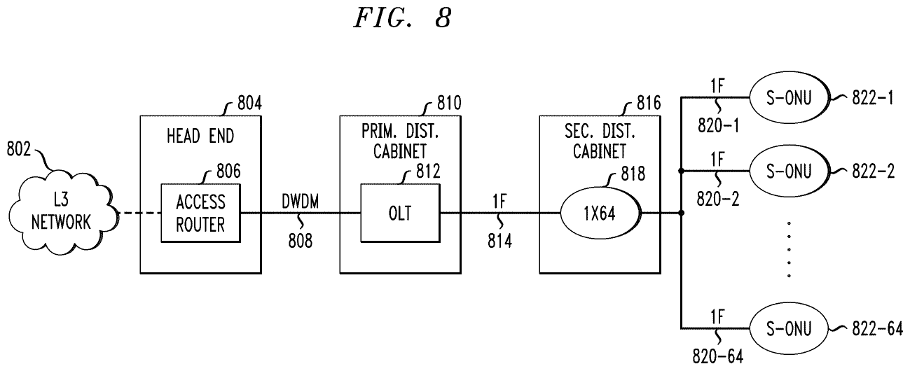

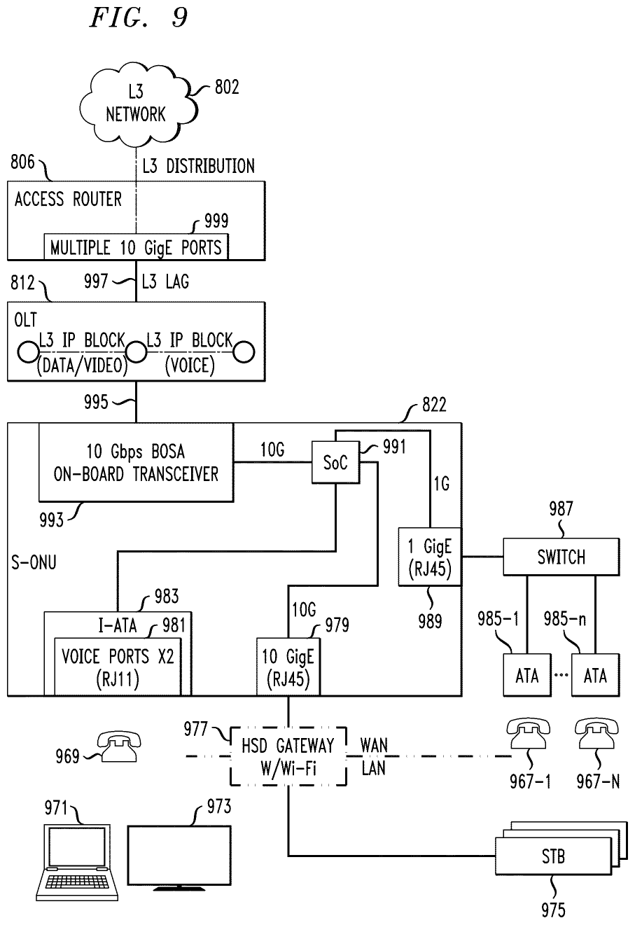

The CPE 106 includes any equipment in the “customers'premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

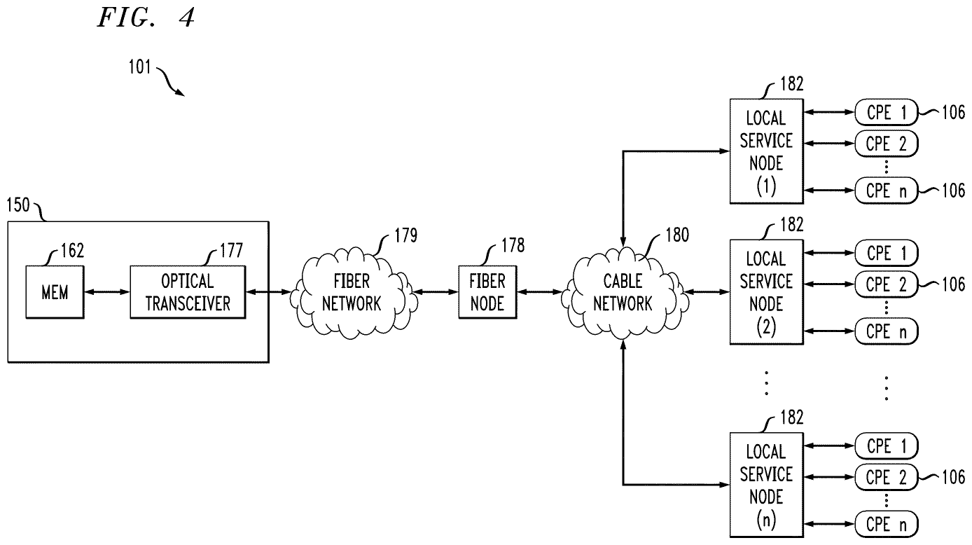

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

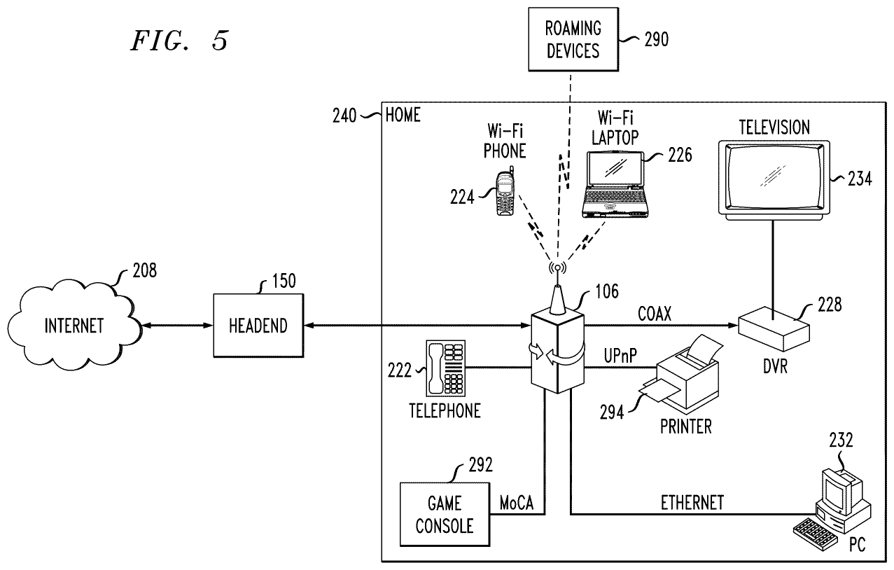

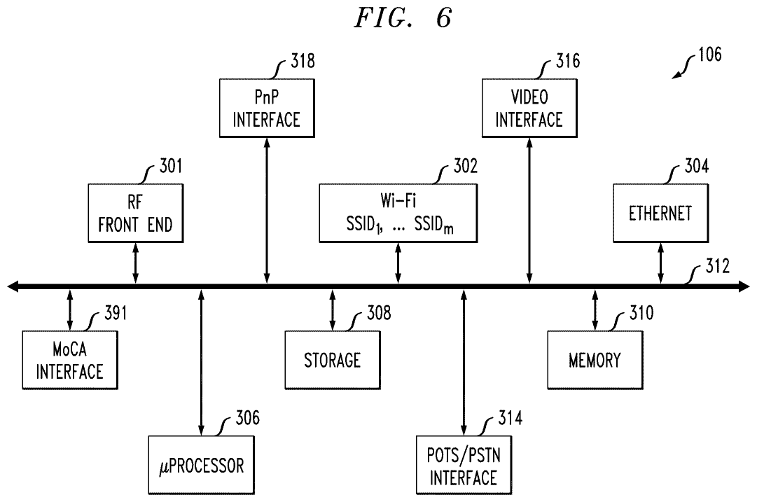

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment—see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n' Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as, for example, packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Principles of the present disclosure will be described herein in the context of apparatus, systems, and methods for electronic devices, networking and network management. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

Generally, techniques are provided for monitoring health of hardware elements which undergo variable thermal stress, such as network devices and the like. In example embodiments, mitigation tasks are identified and implemented based on a result of the monitoring. Example embodiments are described in the context of customer premise equipment (CPE), although the use of the disclosed techniques is contemplated for a variety of hardware elements which undergoes variable thermal stress, including networking equipment, servers, computers, appliances and the like. Unless expressly stated, or apparent from the context, to be limited to CPE, references in the specification to CPE are to be understood to be illustrative of a variety of hardware elements which undergo variable thermal stress. Customer premise equipment (CPE) includes, by way of example and not limitation, access points (APs), cable modems, video distribution equipment, power supplies, routers, optical network units (ONUs), and the like. Each piece of CPE typically includes one or more components which have calculated failure rates that depend on conditions, such as operating temperature, electrical stress, supplier quality, usage environment, and the like. Note that CPE is a non-limiting example of hardware elements which undergo variable thermal stress, such as network elements and/or other electronic devices, which can be monitored and mitigated in accordance with aspects of the invention.

In example embodiments, the CPE is typically estimated to support a certain number of hours between repairable failures based on the components chosen and their calculated failure rates. Failure rates are typically summed for all relevant components in the piece of CPE to produce a mean time between failure (MTBF) estimate that measures CPE reliability within the intended design lifetime of the corresponding hardware element. Heretofore, after the CPE is produced, there has been no continuous re-analysis of the CPE's reliability; i.e., currently, static metrics are employed.

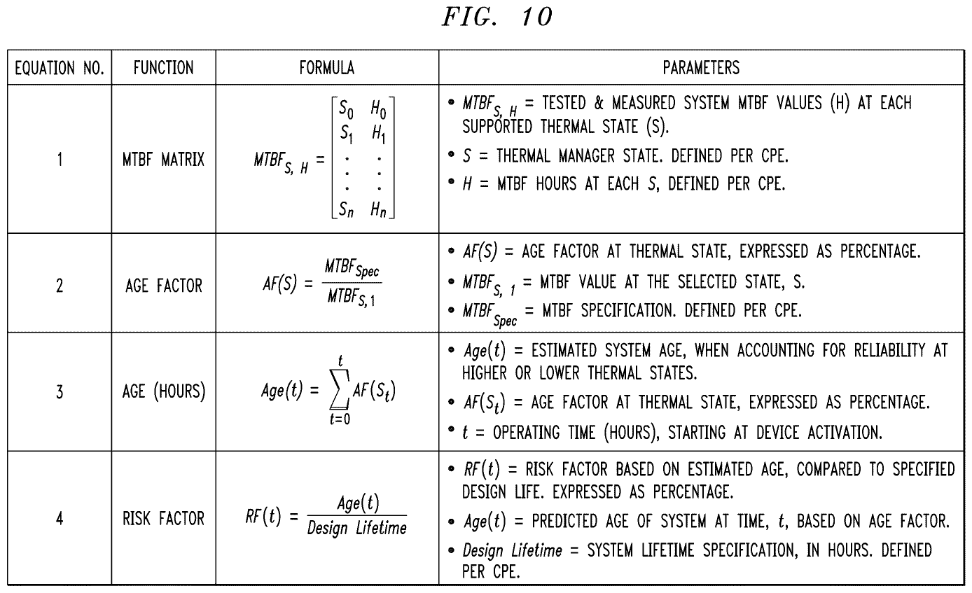

FIG. 10 illustrates various mathematical relationships for determining the health of a piece of CPE (more generally a hardware element which undergoes variable thermal stress), in accordance with example embodiments. As a starting point, referring to equation 1, construct an MTBF matrix that includes a set of thermal manager states, S, defined per CPE (or other hardware element which undergoes variable thermal stress) and the tested/measured MTBF, H, for each state defined per CPE; for example, in hours. The skilled artisan will be able to determine MTBF values for the give state using a variety of analytical and/or experimental techniques depending on the domain; for example, based on MIL-HDBK-217F, Telcordia SR332, Siemens SN 29500, FIDES, UTE 80-810 (RDF2000), and the like. For example, determine a steady state failure rate for each component of the CPE, based on exemplary factors such as generic steady-state failure rate, environmental/load factors, quality, and the like. The skilled artisan will be familiar with such determinations.

A CPE-level steady state failure rate can then be determined; for example, based on a CPE unit environment factor, a count (number) of different components within the CPE, a count (number) of selected components in the CPE, and a steady state failure rate for the selected component(s). The skilled artisan will be familiar with such determinations.

A CPE-level MTBF estimation can then be made based on the steady state failure rate for the CPE, using known techniques. In addition or alternatively, an annual failure rate or the like could be determined.

Currently, there is no re-analysis of the CPE components, and thus no insight into when a failure of a hardware element which undergoes variable thermal stress might occur, or if the reliability is degrading faster than expected. There is currently no metric that is conventionally gathered that would indicate that the CPE should be pulled from a deployment, pulled from circulation, pulled from inventory, and the like. A CPE can continue to operate or be redeployed when its effective reliability has been reduced, causing unexpected failures, unplanned outages for the customer, additional truck rolls to replace the CPE, and the like.

A pertinent in-field contribution to early hardware element failure is increased thermal operating temperature. Hardware elements which undergo variable thermal stress do not conventionally log this information in a way that allows estimation of its effect on a future failure of the hardware element. Current techniques are based on in-lab tests rather than actual field conditions. A hardware element which undergoes variable thermal stress in the field might be located, for example, in an unusually hot environment, causing it to fail faster than would be expected based on lab testing under nominal thermal conditions.

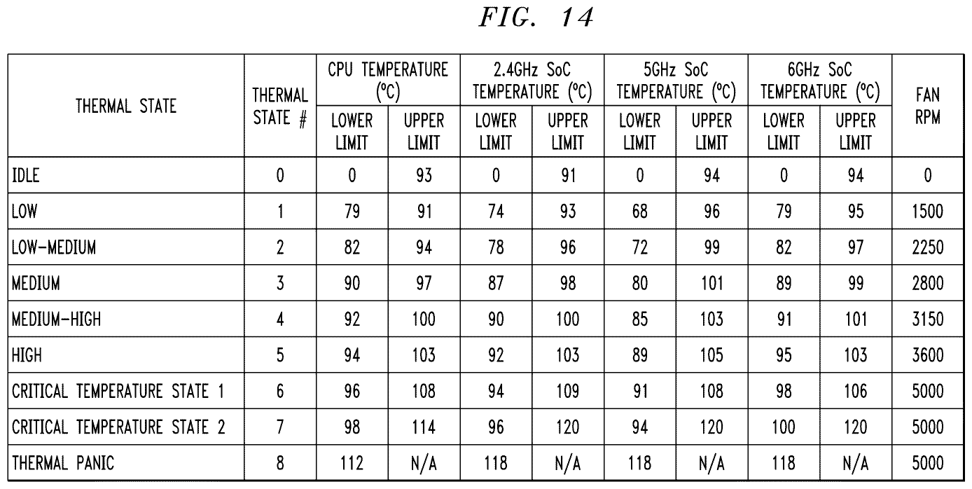

In example embodiments, a health manager defines and tracks multiple states for a hardware element which undergoes variable thermal stress. The health manager can reside, for example, in firmware of the hardware element, or an associated component. The health manager can be, or can include, a thermal manager (refer to FIG. 14 and discussion) that monitors the health of the hardware element based on the current and historical thermal environment. In one or more embodiments, the health manager protects the hardware under different environmental conditions. For example, for each thermal manager state, a test can be conducted and the MTBF estimate can be determined based on various of analytical and/or experimental techniques. In example embodiments, Equation 2 is applied to calculate an age factor (how far above or below the baseline) for each thermal manager state of the hardware element. Considering again the matrix in Equation 1, the matrix can include two columns and n+1 rows numbered 0 through n. The thermal manager state S₀ through S₈ corresponds to the thermal state number from FIG. 14, discussed elsewhere herein. For each thermal manager state S₀ through S₈ the associated value H₀ through H₈ is the number of MTBF hours (or other time units). Considering again the age factor of Equation 2, the age factor AF for a given one of the states S₀ through S₈ (generally AF(S)) is the MTBF specified by the CPE manufacturer divided by the MTBF at the particular state you are interested in knowing the age factor for (in the example in the table, S₁). In essence, one is simply looking for age factor at a specific state, one state at a time. For example, consider the measured/calculated MTBF at a given state, such as S₀, H₀. That is compared to the baseline reliability requirement for that CPE (e.g., 300,000 hours). At the idle thermal state S₀, there might be a measured/calculated MTBF of 800,000 hours. Thus, the actual (measured/calculated) MTBF at state zero is more than 2 times higher (800,000÷300,000=2.67) than the specified value. For each thermal state in the table of FIG. 14, there is a corresponding value of the age factor parameter. For example, at idle the CPE unit lasts 2.67 times the normal MTBF, while in “thermal panic” mode it exhibits only 10% of the normal MTBF. It will accordingly be appreciated that the S₁ through Sₙ values are the different thermal states in the table of FIG. 14 and the matrix of Equation 1, and the Hₙ values are the corresponding MTBF values.

Once Equations 1 and 2 are defined, the age of the hardware element which undergoes variable thermal stress, as defined by Equation 3, and the risk factor, as defined by equation 4, are calculated. The age and risk factor can be determined based on the time of deployment, the time of active operation (where active operation refers to the hardware element being powered on, being actively operated, etc.), and the like. For example, the age and risk factor can be determined once for each hour of deployment or active operation, for each day of the deployment or active operation, and the like based on the active thermal manager state. In Equation 3, what is being considered is the overall relative effective age of a hardware element which undergoes variable thermal stress (e.g., CPE such as a router or the like), including all its components, or a set of related, interconnected, collocated components, such as a router and a modem. For a given time, t, the Age(t) is the sum of all the age factor results; i.e., the current age factor (time t) plus the age factor of every hour (or other appropriate time unit) before that (starting with time t=0). For example, suppose the CPE is at state 0 for hour 100 (time t), which is the most recent hour. The Age(100) is then that value plus the values at hour 99, 98, . . . back to hour 0.

In one or more embodiments, if multiple thermal states are encountered within a specified time period, such as during a given hour, the hardware element (e.g., a controller thereof) will select the state with the longest dwell time. It is noted that different time periods are contemplated, such as 1 second(s), 30 s, 15 minutes, and the like. Consistent units should be employed; if the source data (such as the MTBF estimate, the design lifetime, the age and the like) is not in consistent units, appropriate conversions can be applied as would be apparent to the skilled artisan given the teachings herein.

As CPE deployment continues, the age and risk factor will continue to rise (per Equations 3-4). In one or more embodiments, the risk factor (see Equation 4) is monitored periodically or continuously throughout the CPE deployment and an action can be taken according to the thresholds set by the governing organization.

As noted, FIG. 10 illustrates various mathematical relationships for determining the health of a piece of CPE (more generally a hardware element which undergoes variable thermal stress), or a set of related, interconnected, collocated components, such as a router and a modem (as opposed to an overall system), in accordance with example embodiments. Equations 1-4 define the process of modeling CPE usage risk for a given time interval, t, within the design lifetime. In particular, Equation 1 defines an MTBF matrix that includes a set of thermal manager states, S, defined per CPE and the tested/measured MTBF, H, for each state defined per CPE; for example, in hours. The matrix elements of Equation 1 are determined through CPE testing and/or analytical techniques. Typically, MTBF declines with increasing temperature.

Equations 2-4 apply the measured MTBF values (Equation 1) and calculate the usage risk based on the hardware element's MTBF estimation and design lifetime specifications. Equation 2 defines an age factor (expressed as a fraction; alternatively, as a percentage - the equation in FIG. 10 shows a fraction but the same can be multiplied by 100 to obtain a percentage) based, for example, on the MTBF value at the selected state, S, and the MTBF specification defined per CPE.

Equation 3 defines the estimated age of a hardware element which undergoes variable thermal stress, accounting for reliability at higher or lower than nominal thermal states, based, for example, on the age factor at a given thermal state and an operating time starting at hardware element activation measured, for example, in hours. As noted, the age factor can be expressed as a fraction or percentage.

Equation 4 defines a risk factor (expressed as a fraction; alternatively, as a percentage - the equation in FIG. 10 shows a fraction but the same can be multiplied by 100 to obtain a percentage) per time, t, which fluctuates based on the CPE's active thermal state and grows over the deployment time. In example embodiments, the risk factor per time is based on a predicted age of the hardware element at a given time (based on the age factor) and a design lifetime specification for the corresponding CPE (measured, for example, in hours).

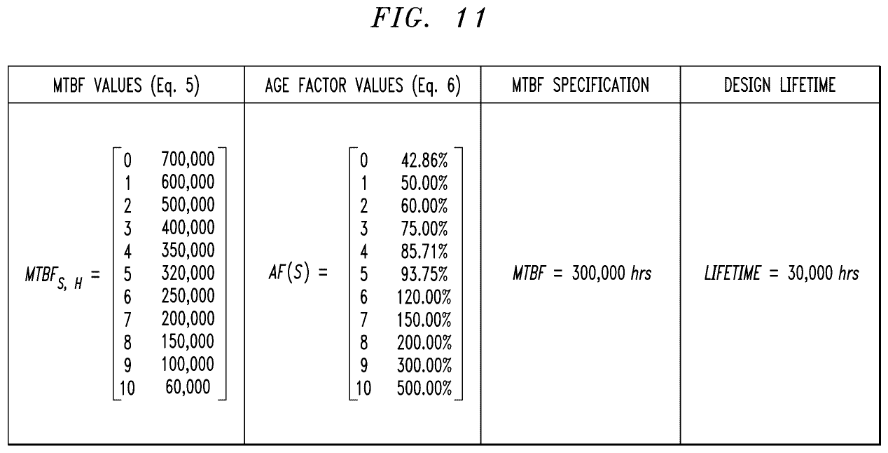

FIG. 11 illustrates example MTBF values and age factor values for a hardware element which undergoes variable thermal stress having an MTBF specification of 300,000 hours and a design lifetime of 30,000 hours. The values of FIG. 11 are leveraged to calculate the progressive age of the hardware element (Age(t)) and resulting risk factor (RF(t)) over the CPE's lifetime. It is noted that the MTBF value and design lifetime specifications are configurable for each hardware element which undergoes variable thermal stress.

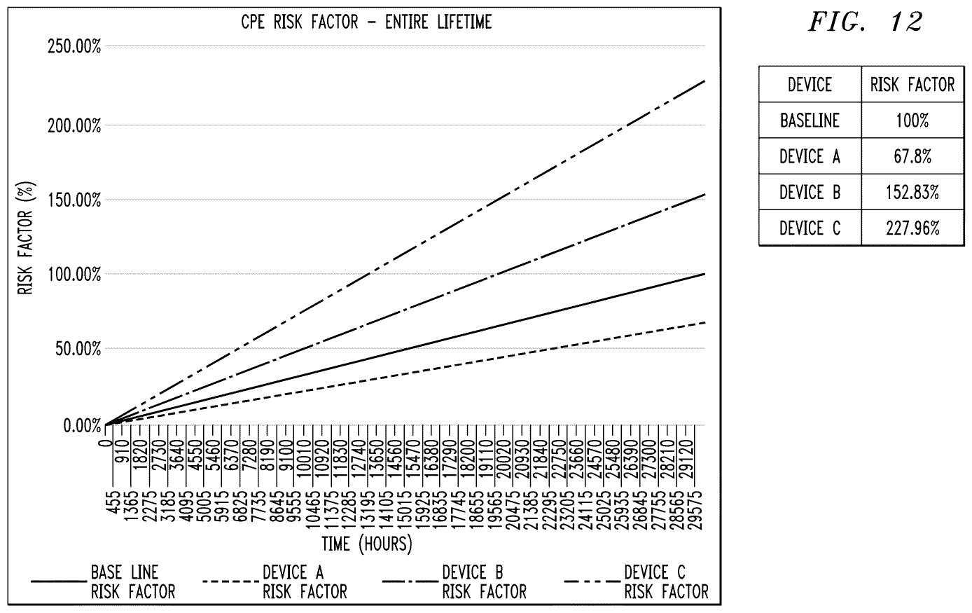

FIG. 12 is a graph of a CPE risk factor (general example) over the entire lifetime of a baseline hardware element which undergoes variable thermal stress and example hardware elements A-C (referred to in the drawings as devices A-C), in accordance with example embodiments. The baseline represents a hardware element usage pattern with a constant age factor equal to 1 over the entire lifetime of the baseline hardware element. Hardware elements A, B, and C all vary in active thermal states over the deployment lifetime. A higher risk factor indicates a greater usage at higher thermal manager states. Hardware element A undergoes low usage (e.g., in an idle/cool state) and has a low risk for damage or early repair. The baseline operates at specification. Hardware element B has slightly more risk. Based on the slope of the risk factor for hardware element C, it is noted that hardware element C may not operate properly over the expected five years lifespan of hardware element C, and may need to be replaced early or subjected to a less stressful service environment (e.g., move to a cooler location). In one or more embodiments, a threshold for replacement can be defined; this threshold can be user-configurable and/or organization dependent, for example. When the CPE or other hardware element which undergoes variable thermal stress is within the threshold value of the end of life, the hardware element can be mitigated/remedied (or mitigation can be facilitated), such as pulled from service, marked for scrapping upon return, designated for enhanced cooling, having a message sent to the end user (e.g., to move to a cooler/better ventilated location), or the like. For example, suppose the hardware element has run for a predetermined time at a predetermined temperature and is within an end-of-life threshold. A message could be sent over the network to cause the hardware element's fan to run at maximum speed for the rest of the hardware element's service. Generally, a population of CPE or other hardware elements which undergo variable thermal stress can be monitored as set forth herein. Because of the expense of a proactive truck roll with pre-emptive hardware element replacement, flagging a hardware element as high risk may be appropriate in some instances, and the hardware element can be replaced when a truck is in the area for some other reason.

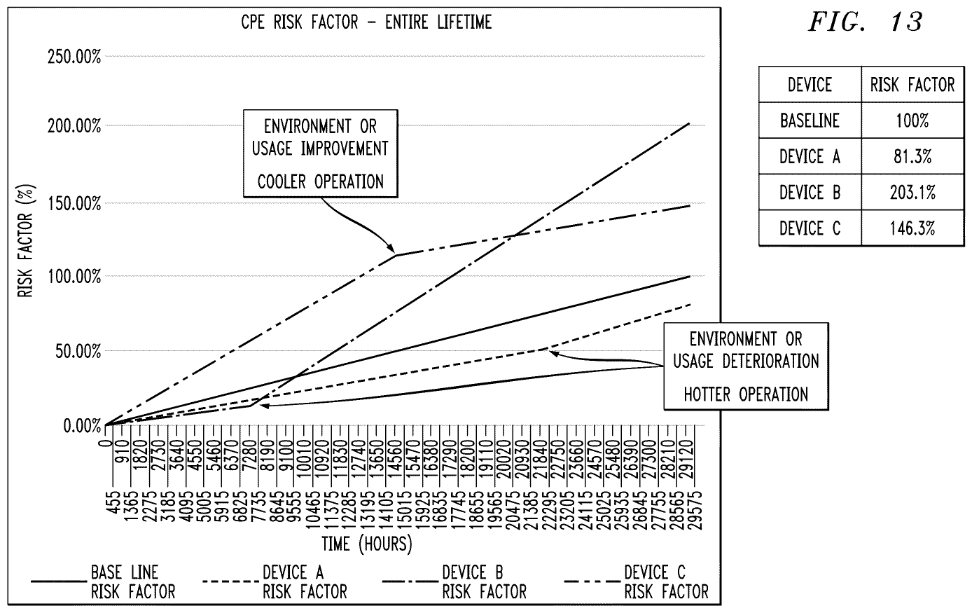

FIG. 13 is a graph of a CPE risk factor (multi use case example) over the entire lifetime of a baseline hardware element and example hardware elements A-C, in accordance with example embodiments. Hardware element A has normal usage for 75% of its expected lifespan, then experiences a rise in active thermal states due to natural dust collection and cluttering of the CPE placement area. Hardware element B experiences minimal usage for the first 25% of its expected lifespan. This effect changes when the user wraps hardware element B in a blanket for the remainder of its expected life, adversely impacting the health of hardware element B. Hardware element C experiences normal usage in a hot environment for the first 50% of its expected lifespan, then the hardware element C is moved to a more proper placement (such as a cooler environment) with normal usage.

One or more exemplary embodiments compute risk factors for a given CPE deployment based on how the actual usage compares to the reliability specification accepted for the CPE's lifetime. By cross referencing the high thermal states with data usage counters on the CPE, it can be determined if the increased risk was primarily influenced by environmental or data usage. The organization that controls the CPE's deployment is then enabled to determine its own appropriate risk factor thresholds for when the CPE should receive maintenance or be withdrawn from production. Given the teachings herein, the skilled artisan can determine suitable threshold values heuristically, depending on appropriate factors such as the application, cost of replacement (parts versus labor) for field repairs, risk of a bad result if a unit fails in service (e.g., failure of critical infrastructure used for emergency notifications unacceptable versus occasional failure of a game console or other entertainment system may be acceptable), and the like. Indeed, given the teachings herein, the skilled artisan can determine approximately what threshold is acceptable for a particular network (or other) application and can pick an initial value for the threshold. If the initial threshold results in too many units being pulled from service before they are worn out, the threshold can be adjusted (e.g., higher, replace less often). If too many in-service failures occur, the threshold can be adjusted (e.g., lower, replace more often

FIG. 14 is a table of hardware element parameters based on thermal state, in accordance with example embodiments. Each thermal state has corresponding specifications for parameters such as lower and upper limits on hardware element temperature (in degrees centigrade (° C.)) for different operating speeds and the operating speed of the fan (in revolutions per minute (RPMs)). Specifically, in the example, the nine thermal states 0 through 8 range from “idle” to “thermal panic.” For each state, lower and upper temperature limits are defined for the CPU, 2.4 GHz system on chip (SoC), 5 GHz SoC, and 6 GHz SoC. The fan RPM is also defined. At some point, the RF components can be powered down if the temperature rises too high. To generate the table in FIG. 14, for example, in the lab, operate the unit at various conditions. In one or more embodiments, the independent variables include the hardware element loading, how much power it is consuming, and the external environmental conditions. For example, thermal state 1 is “low.” In a room temperature setting, say 25 C or slightly less, state 1 would be entered at a fairly light power consumption/usage; such as just a little bit above idle. However, for the same power dissipation in a hot room (e.g., 40 C), the state might “jump” up to state 3 or 4, because the hardware element is growing hotter even with the same amount of load. In this aspect, the chipsets grow hotter from a combination of power and external environment; the chips getting hotter triggers an increase in the fan speed and results in a higher thermal state.

To summarize, in one or more embodiments, the thermal state is based on the temperature of important component(s) and there are a number of combinations of ways that can lead to being in a certain state (such as power and ambient conditions—e.g., hot environment at low power, cool environment at high power, medium environment at medium power). In one or more embodiments, the fan RPM is set by a controller based on the thermal state which is, in turn, based on measured temperature. The controller can be suitably programmed: for example, the controller detects that the CPE is in thermal state 4 and therefore it is desired for the fan to turn at 3150 RPM. In the example in the table, 5000 RPM is the derated maximum fan RPM and is also selected as a maximum value for noise reduction considerations. It is worth noting that the nine thermal states 0 through 8 in FIG. 14 constitute a non-limiting example and other embodiments can have fewer or more states. Furthermore, some embodiments could employ a continuous function instead of discretized “buckets.”

It is worth noting that calculations of the parameters in FIG. 10 could be done locally on-board the CPE, “in the cloud” based on data gathered via telemetry, in some intermediate location, or any combination thereof.

In some instances, if one or more important temperatures become excessive, one or more subsystems can be disabled. This aspect can be captured in the hardware element health state in some instances; for example, the temperature factor would lower and that part of the failure rate would improve. That is to say, at some point (“thermal panic,” e.g.), one of the mitigating actions could be to leave the fan running and turn off power to one or more chip(s). There can be intermediate states where only some subsystems are shut down, and a state where all subsystems are shut down, for example. This partial or complete shut-down state could be reflected in the lab test data, for example. For example, in thermal state 6, Critical Temperature State 1, the 6 GHz SoC might have two instead of four RF chains running. The test that would be run to obtain the MTBF in thermal state 6 would have two instead of four RF chains running so the 6 GHz SoC failure rate would be with only two not four RF chains running. RF chains are a non-limiting example; any appropriate subsystem can be shut down as desired to reduce thermal load and/or prevent damage. Referring again to FIG. 14, in one or more embodiments, go through MTBF testing and/or calculations to obtain the failure rates for individual components of the CPE and for the overall CPE unit itself. In the lab, program the router or other CPE to operate at thermal state 0 through thermal state 8. Determine the MTBF with the router or other CPE sitting at each state. The MTBF at each state can be determined/calculated by varying the environment and/or device loading until the target state is achieved. Temperature factor can then be calculated based on measured component data.

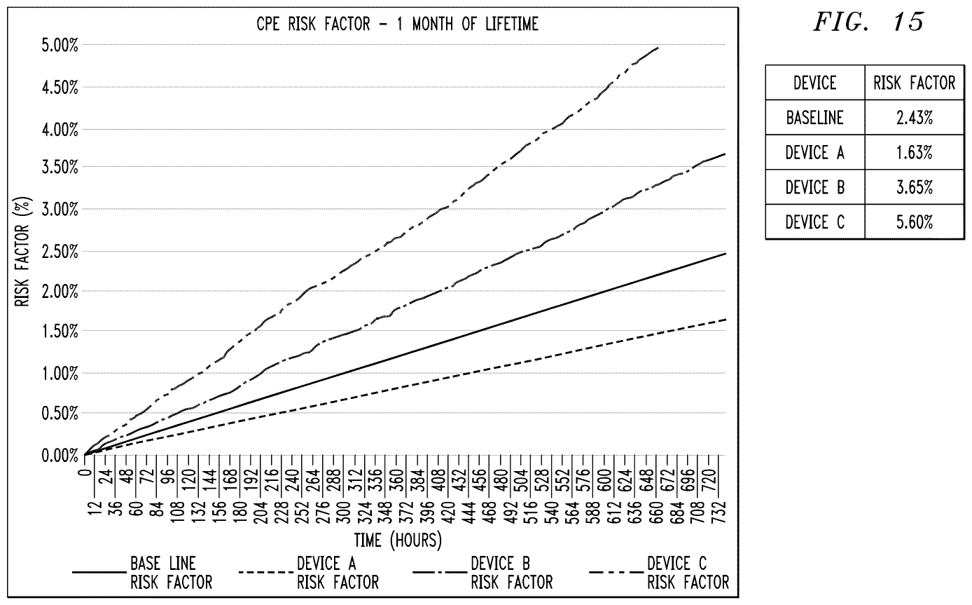

FIG. 15 is a graph of a CPE risk factor over the entire lifetime of a baseline hardware element which undergoes variable thermal stress and example hardware elements A-C, in accordance with example embodiments. The baseline represents a hardware element usage pattern with a constant age factor equal to 1 over the entire lifetime of the baseline hardware element. Hardware elements A, B, and C all vary in active thermal states over the deployment lifetime. A higher risk factor indicates a greater usage at higher thermal manager states. It is noted that, based on the slope of the risk factor for hardware element C, hardware element C may not operate properly over the expected five year lifespan of the hardware element.

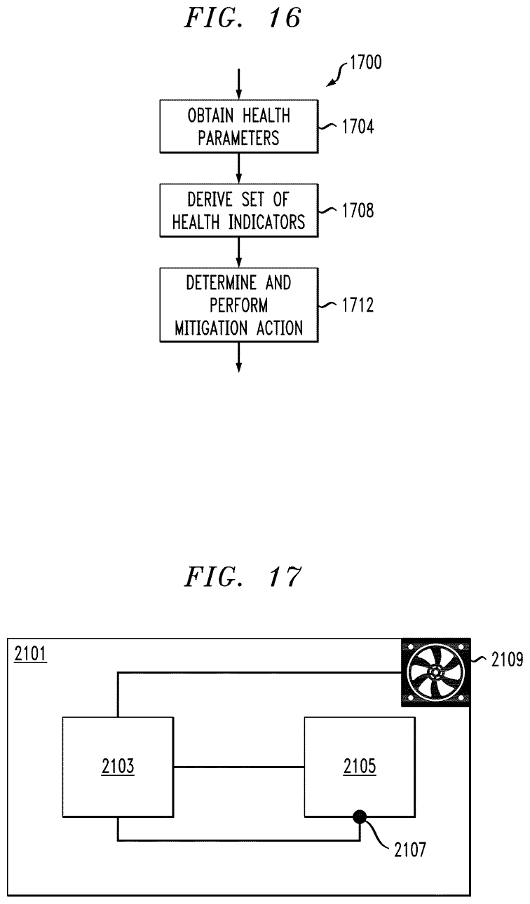

FIG. 16 is a flowchart of an example method 1700 for monitoring health of a hardware element which undergoes variable thermal stress, in accordance with example embodiments. Generally, a population of hardware elements are flagged as being at high risk base on the monitored health. In example embodiments, health parameters are obtained from the hardware element(s) (operation 1704). For example, the amount of time that each hardware element spends in each state can be obtained. A set of health indicators is derived based, for example, on the obtained health parameters (operation 1708). Based on the set of health indicators, a mitigation action is determined and performed (operation 1712). The mitigation actions include: 1) re-assessing the health status at a specified future time; 2) replacing the corresponding hardware element ; 3) performing an action to extend the life of the hardware element; and the like. The hardware element can be replaced immediately, at a specified future time, opportunistically (such as when a technician is in the vicinity of the hardware element), and the like. The action to extend the life of the hardware element includes moving the hardware element to a cooler location, running a cooling apparatus at a higher rate (such as a fan or air conditioning system) to cool the hardware element, and the like.

In some cases, calculations can be carried out offline on the CPE or other hardware element which undergoes variable thermal stress, and the user is alerted to a problem via an illuminated LED or some other mechanism. However, in one or more embodiments, some form of internet (or other network or internetwork) connectivity is available. In this latter aspect, for example, data can be sent to a central server or the like via telemetry over the network. The router or other CPE or hardware element locally collects the time at each thermal state and sends the time, state data to the server or other cloud elements to calculate the risk. Problems could be flagged in a management console or the like.

Given the discussion thus far, it will be appreciated that, in general terms, an exemplary method, according to an aspect of the invention, includes the step 1704 of gathering a time series of reliability-pertinent data for at least one hardware element. A further step 1708 includes determining a risk factor for the at least one hardware element based on the time series of reliability-pertinent data. A still further step 1712 includes, responsive to the risk factor RF(t) of the at least one hardware element having a predetermined relationship to a baseline, facilitating at least one remedial action for the at least one hardware element.

In a non-limiting example, the reliability-pertinent data includes operating temperature.

In a non-limiting example, the gathering includes gathering over a network (for example, via telemetry).

In one or more embodiments, the gathering and determining are carried out for a plurality of hardware elements including the at least one hardware element; for example, many CPE within a network as per FIGS. 1-6, 8, and 9. As noted, unless expressly stated, or apparent from the context, to be limited to CPE, references in the specification to CPE are to be understood to be exemplary of a variety of hardware elements which undergo variable thermal stress; when recited specifically in the claims, CPE refers to CPE.

Various remedial actions can be caried out or otherwise facilitated. For example, in some cases, the at least one remedial action includes replacement of the at least one hardware element. In another example, the at least one remedial action includes repair of the at least one hardware element. In still another example, the at least one remedial action includes designation of the at least one hardware element for at least one of scrapping and future repair. In a further example, the at least one remedial action includes enhanced cooling. These examples are non-limiting.

In one or more embodiments, the determining includes, e.g., as per Equation 2,for each of the hardware elements, determining an age factor for each of a plurality of prior thermal states and a current thermal state as a specified mean failure time parameter divided by a mean failure time parameter for each given thermal state. The determining further includes, e.g., as per Equation 3, for each of the hardware elements, determining an age at a current time as a sum of the age factor for the current thermal state plus the age factors for each of the plurality of prior thermal states. This can be, for example, by binning operating time into hours or other predetermined time periods, or by integrating continuously. The determining still further includes, e.g., as per Equation 4, for each of the hardware elements, determining a risk factor at a current time as the age at the current time divided by a corresponding design lifetime.

A variety of mean failure time parameters can be employed. For example, as per Equation 2, the mean failure time parameter can be mean time between failures (MTBF) (i.e., for both the mean failure time parameter for each given thermal state and the corresponding specified mean failure time parameter).

Exemplary parameters other than MTBF can be mean time to failure (MTTF), mean time to repair (MTTR), and the like. A similar process can be used to substitute MTTF or MTTR for MTBF in Equations 1 and 2; compare performance at a thermal state to whatever the specification is for the given reliability metric. For example, if analyzing a light-emitting diode (LED) instead of a CPE unit with many different hardware components, MTTF instead of MTBF could be used since the LED is not repairable. Equations 3 and 4 then proceed in a similar manner to the MTBF example.

In some instances, the predetermined relationship to the baseline is 100%; i.e., the Age(t) value equals the specified device lifetime.

In some instances, the predetermined relationship to the baseline is a percentage less than 100% (which is essentially the same as a fraction less than one); i.e., the Age(t) value is less than the specified device lifetime (appropriate, for example, for a critical hardware element such as one providing emergency telephone, life support, or the like).

In some instances, the predetermined relationship to the baseline is a percentage greater than 100% (which is essentially the same as a fraction greater than one); i.e., the Age(t) value is greater than the specified device lifetime (appropriate, for example, for a non-critical hardware element such as a gaming console).

Generally, referring to FIG. 12, the risk factor for the Baseline Device is 100% (which is essentially the same as a fraction equal to one); the CPE is at a thermal state that correlates directly to the MTBF specification. Device C is operating at more than twice that risk factor which means that the MTBF at its thermal state is much lower than the baseline CPE specification. Device B is operating at about 1.5 times the baseline risk factor; while Device A is operating at only about ⅔ of the baseline risk factor and would be expected to last longer than a unit operating at baseline. Generally, increased heat implies a lower MTBF and a higher AF(S).

In a non-limiting example, the network is a cable network (understood to include an HFC network as well as a “pure” cable network without any fiber portions) and the plurality of hardware elements include customer premise equipment (CPE) of the cable network.

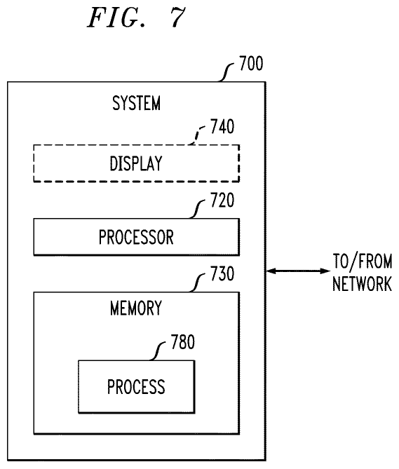

In another aspect, a non-transitory computer readable medium includes computer executable instructions which when executed by a computer cause the computer to perform any one, some, or all of the method steps set forth herein. See, e.g., system 700 of FIG. 7, which can be located, for example, in any suitable location of the networks of FIGS. 1-6, 8, and 9, such as a national data center, regional data center, head end, hub, etc.

In an even further aspect, an exemplary system 700 includes a memory 730; and at least one processor 720, coupled to the memory 730, and operative to carry out or otherwise facilitate any one, some, or all of the method steps set forth herein. Optionally, the system further includes the at least one hardware element (e.g., CPE 106); and a network (e.g., FIGS. 1-6, 8, and 9) coupled to the at least one processor and the at least one hardware element. The at least one processor is operative to gather the time series over the network. In some cases, the at least one processor is operative to gather and determine for the plurality of hardware elements including the at least one hardware element.

In another aspect, referring, for example, to FIG. 17, an exemplary hardware element 2101 (e.g., a “stand-alone” implementation with on-board computations) includes at least one functional electronic circuit 2105; and a controller 2103 coupled to the at least one functional electronic circuit (and optionally to a fan 2109). The controller 2103 is configured to gather a time series of reliability-pertinent data for the at least one functional electronic circuit; determine a risk factor for the at least one functional electronic circuit based on the time series of reliability-pertinent data; and, responsive to the risk factor of the at least one functional electronic circuit having a predetermined relationship to a baseline, facilitating at least one remedial action for the at least one functional electronic circuit. For example, a thermocouple, thermistor, or other temperature-measuring sensor (generally, 2107) is located on the at least one functional electronic circuit 2105 and is coupled to digital readout circuitry in controller 2103. Another coupling (shown in the middle of FIG. 17, not separately numbered), can be used to implement mitigation. For example, the middle coupling normally enables power to at least a portion of the circuit 2105 by energizing a transistor, but when the risk factor is too high, it disables power to at least a portion of the circuit 2105. In addition or alternatively, when the risk factor is too high, controller 2103 causes fan 2109 to speed up.

In some cases, the reliability-pertinent data includes operating temperature.

In one or more embodiments, the controller is configured to determine by determining an age factor of the at least one functional electronic circuit for each of a plurality of prior thermal states and a current thermal state as a specified mean failure time parameter divided by a mean failure time parameter for each given thermal state ; determining an age at a current time as a sum of the age factor for the current thermal state plus the age factors for each of the plurality of prior thermal states; and determining a risk factor at a current time as the age at the current time divided by a corresponding design lifetime.

The mean failure time parameter can be, for example, mean time between failures (MTBF).

Controller 2103 can implement the logic discussed herein, including in Equations 1-4, using software, firmware, an ASIC, an FPGA, and/or custom digital circuitry (e.g., CMOS logic). Given the teachings herein, the skilled artisan can use known techniques to synthesize digital circuitry to implement the controller 2103. The couplings can be wire traces on an interposer or printed circuit board, or the elements 2103 and 2105 could be integrated on the same chip and the couplings could be wires on the chip.

The at least one functional electronic circuit 2105 can be, for example, an SoC implementing router functionality such as a 2.4 GHz SoC, a 5 GHz SoC, and/or a 6 GHz SoC. The at least one functional electronic circuit 2105 can be other types of circuitry as well; e.g., modem; another type of router; laptop or desktop computer; or the like—indeed, any electronic circuit for which: temperature can be determined, a table such as that of FIG. 14 can be constructed, and a processor/controller can control operation based on the determined (e.g., measured) temperature and the table.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
gathering a time series of reliability-pertinent data for at least one hardware element;
determining a risk factor for the at least one hardware element based on the time series of reliability-pertinent data; and
responsive to the risk factor of the at least one hardware element having a predetermined relationship to a baseline, facilitating at least one remedial action for the at least one hardware element.

2. The method of claim 1, wherein the reliability-pertinent data comprises operating temperature.

3. The method of claim 2, wherein the gathering comprises gathering over a network.

4. The method of claim 3, wherein the gathering and determining are carried out for a plurality of hardware elements including the at least one hardware element.

5. The method of claim 4, wherein the at least one remedial action comprises replacement of the at least one hardware element.

6. The method of claim 4, wherein the at least one remedial action comprises repair of the at least one hardware element.

7. The method of claim 4, wherein the at least one remedial action comprises designation of the at least one hardware element for at least one of scrapping and future repair.

8. The method of claim 4, wherein the at least one remedial action comprises enhanced cooling.

9. The method of claim 4, wherein the determining comprises:
for each of the hardware elements, determining an age factor for each of a plurality of prior thermal states and a current thermal state as a specified mean failure time parameter divided by a corresponding mean failure time parameter for each given thermal state;
for each of the hardware elements, determining an age at a current time as a sum of the age factor for the current thermal state plus the age factors for each of the plurality of prior thermal states;
for each of the hardware elements, determining a risk factor at a current time as the age at the current time divided by a corresponding design lifetime.

10. The method of claim 9, wherein the mean failure time parameter comprises mean time between failures (MTBF).

11. The method of claim 10, wherein the predetermined relationship to the baseline comprises 100%.

12. The method of claim 10, wherein the predetermined relationship to the baseline comprises a percentage less than 100%.

13. The method of claim 10, wherein the predetermined relationship to the baseline comprises a percentage greater than 100%.

14. The method of claim 4, wherein the network comprises a cable network and the plurality of hardware elements comprise customer premise equipment (CPE) of the cable network.

15. A non-transitory computer readable medium comprising computer executable instructions which when executed by a computer cause the computer to perform the method of:
gathering a time series of reliability-pertinent data for at least one hardware element;
determining a risk factor for the at least one hardware element based on the time series of reliability-pertinent data; and
responsive to the risk factor of the at least one hardware element having a predetermined relationship to a baseline, facilitating at least one remedial action for the at least one hardware element.

16. A system comprising:
a memory; and
at least one processor, coupled to the memory, and operative to:
gather a time series of reliability-pertinent data for at least one hardware element;
determine a risk factor for the at least one hardware element based on the time series of reliability-pertinent data; and
responsive to the risk factor of the at least one hardware element having a predetermined relationship to a baseline, facilitate at least one remedial action for the at least one hardware element.

17. The system of claim 16, wherein the reliability-pertinent data comprises operating temperature.

18. The system of claim 17, further comprising:
the at least one hardware element; and
a network coupled to the at least one processor and the at least one hardware element;
wherein the at least one processor is operative to gather the time series over the network.

19. The system of claim 18, wherein the at least one processor is operative to gather and determine for the plurality of hardware elements including the at least one hardware element.

20. The system of claim 19, wherein the at least one processor is operative to determine by:
for each of the hardware elements, determining an age factor for each of a plurality of prior thermal states and a current thermal state as a specified mean failure time parameter divided by a corresponding mean failure time parameter for each given thermal state;
for each of the hardware elements, determining an age at a current time as a sum of the age factor for the current thermal state plus the age factors for each of the plurality of prior thermal states;
for each of the hardware elements, determining a risk factor at a current time as the age at the current time divided by a corresponding design lifetime.

21. The system of claim 20, wherein the mean failure time parameter comprises mean time between failures (MTBF).

22. The system of claim 19, wherein the network comprises a cable network and the plurality of hardware elements comprise customer premise equipment (CPE) of the cable network.

23. A hardware element comprising:
at least one functional electronic circuit; and
a controller coupled to the at least one functional electronic circuit, wherein the at least one controller is configured to:
gather a time series of reliability-pertinent data for the at least one functional electronic circuit;
determine a risk factor for the at least one functional electronic circuit based on the time series of reliability-pertinent data; and
responsive to the risk factor of the at least one functional electronic circuit having a predetermined relationship to a baseline, facilitating at least one remedial action for the at least one functional electronic circuit.

24. The hardware element of claim 23, wherein the reliability-pertinent data comprises operating temperature.

25. The hardware element of claim 24, wherein the controller is configured to determine by:
determining an age factor of the at least one functional electronic circuit for each of a plurality of prior thermal states and a current thermal state as a specified mean failure time parameter divided by a corresponding mean failure time parameter for each given thermal state;
determining an age at a current time as a sum of the age factor for the current thermal state plus the age factors for each of the plurality of prior thermal states;
determining a risk factor at a current time as the age at the current time divided by a corresponding design lifetime.

26. The hardware element of claim 25, wherein the mean failure time parameter comprises mean time between failures (MTBF).
